(19) United States
(12) Patent Application Publication
(10) Pub. No.: US 2019/0264755 A1
(43) Pub. Date: Aug. 29, 2019

(54) DOG CLUTCH HAVING A SYNCHRONIZING MECHANISM

(71) Applicant: Schaeffler Technologies AG & Co. KG, Herzogenaurach (DE)

(72) Inventors: Sebastian Giehl, Burgebrach (DE); Horst Hartmann, Aurachtal (DE)

(73) Assignee: Schaeffler Technologies AG & Co. KG, Herzogenaurach (DE)

(21) Appl. No.: 16/331,169

(22) PCT Filed: Nov. 7, 2017
(86) PCT No.: PCT/DE2017/100944

§ 371 Date: Mar. 7, 2019

(30) Foreign Application Priority Data
Nov. 16, 2016 (DE) 102016222539.1

(51) Int. Cl. F16D 23/04; F16D 11/14

(52) U.S. Cl. CPC F16D 23/04; F16D 2011/008; F16D 11/14

(57) ABSTRACT

A clutch includes a first disk-shaped clutch body, a second disk-shaped clutch body, and a synchronizing mechanism. The first disk-shaped clutch body has a first face spline formed as a first claw-type toothing. The second second disk-shaped clutch body has a second face spline formed as a second claw-type toothing. The second disk-shaped clutch body is axially spaced from the first disk-shaped clutch body and axially movable against the first disk-shaped clutch body to engage the second face spline with the first face spline. The synchronizing mechanism is for synchronizing a rotational speed of the first disk-shaped clutch body to a rotational speed of the second disk-shaped clutch body.

### CROSS-REFERENCE TO RELATED APPLICATIONS

This application is the United States National Phase of PCT Appln. No. PCT/DE2017/100944 filed Nov. 7, 2017, which claims priority to German Application Nos. DE102016222539.1 filed Nov. 16, 2016, the entire disclosures of which are incorporated by reference herein.

### TECHNICAL FIELD

The disclosure concerns a clutch having two disk-shaped clutch bodies with face splines and a synchronizing mechanism for synchronizing the rotation speeds of the clutch bodies before engagement. The clutch bodies are axially spaced from each other and the one clutch body is arranged so as to be axially movable against the other clutch body to achieve engagement of the face splines.

### BACKGROUND

DE 10 2014 209 936 B3 discloses a synchronizing mechanism for synchronizing the rotation speed of a clutch or brake of an automatic gearbox, inducing a first and a second disk each having face splines. The disks are axially spaced from each other and the one disk is axially movable against the other disk to achieve engagement of the face splines. At least one disk is connected rotationally fixedly to a synchronizer ring against which the disk can be moved axially against a return force. The synchronizer ring has a run-up face by means of which, on a movement of the disks against each other, it runs against a run-up face of the other disk.

The toothing in DE 10 2014 209 936 B3 is configured as roof-type toothing, i.e., the tooth flanks of a tooth run together from the tooth foot to the tooth head. With such face splines, the torques to be transmitted generate a high axial force component which presses the clutch disks apart.

### SUMMARY

A clutch according to the disclosure has face splines formed as claw-type toothing. A spring element is provided to release the clutch. To simplify the engagement of the teeth of the claw-type toothings, the claw-type toothings include roof-type toothings. The teeth of the claw-type toothings are formed so as to be substantially rectangular in outline and have tooth flanks which are formed parallel or almost parallel to each other. Here, the teeth of the claw-type toothing may have an undercut. This means that the tooth flanks run together in a wedge shape in an axially parallel direction so that a tooth foot is narrower than a tooth head. With such a configuration of the tooth flanks, an applied torque exerts an axial force which draws the clutch bodies together. This measure guarantees that the connection of the clutch bodies cannot be released during torque transmission.

In an exemplary embodiment, it is provided that the tooth flanks are formed rising slightly in the axially parallel direction, so that a tooth foot is wider than a tooth head. This measure facilitates the mutual engagement of the face splines on closure of the clutch, and release of the clutch is possible without problems. The rising tooth flank angle of the clutch is formed sufficiently flat that only a very slight axial force component is generated, so that a setting force for closing and holding the clutch closed is very low even at high torque levels.

To create a return force for releasing the clutch, at least one cup spring, a cup spring packet, for example, is provided which coaxially surrounds a gear part, e.g., a shaft. The shaft serves as a guide for an inner diameter of the cup spring. The cup spring is axially supported on a clutch body and on a synchronizer ring on the other clutch body which is arranged spaced therefrom. With this arrangement, the rotation speeds of the clutch bodies are synchronized before engagement of the face splines. In this way, the synchronizer ring is moved by means of the cup spring so far that the synchronizer ring comes into frictional contact with the clutch body. To this end, the synchronizer ring and the clutch body have a common friction face, e.g., a peripheral conical friction face.

In a second exemplary embodiment, to increase the cup spring force, the cup spring or a cup spring packet with greater diameter is used without requiring larger installation space. To this end, the outer diameter of the cup spring rests on a guide of the gear part, e.g., on a housing receiving the shaft. In this arrangement, the cup spring surrounds the clutch body coaxially outside the face splines.

### BRIEF DESCRIPTION OF THE DRAWINGS

Two exemplary embodiments of the disclosure are shown in the drawings and described below. The drawings show:

FIG. 1 shows a dog clutch with face splines in perspective view.

FIG. 2 shows the dog clutch in cross-section in diagrammatic depiction.

FIG. 3 shows diagrammatically in cross-section, a second exemplary embodiment with a cup spring arranged outside the claw-type toothing.

### DETAILED DESCRIPTION

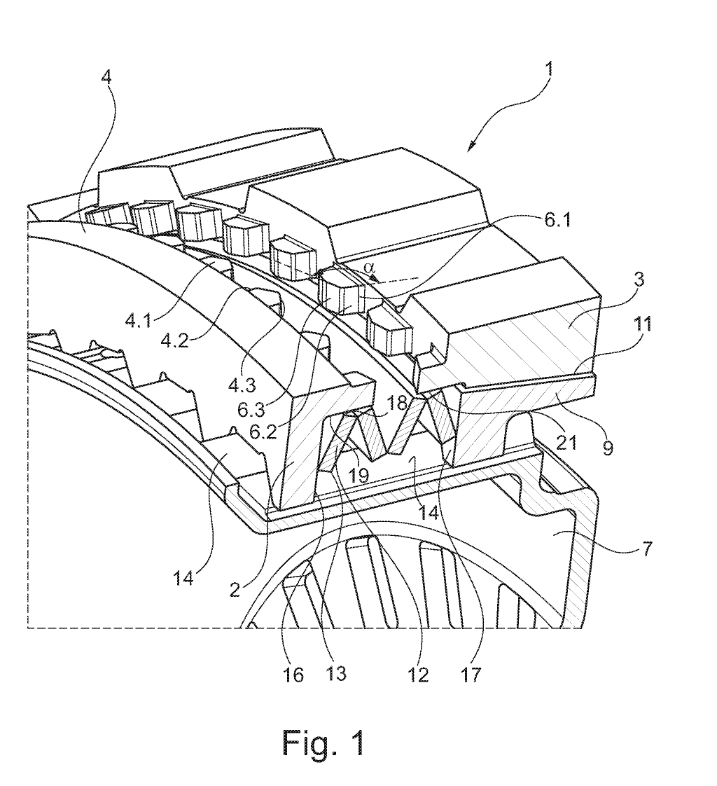

According to FIG. 1, a clutch 1 has two disk-like clutch bodies 2, 3 with face splines, of which at least one is arranged so as to be movable towards and away from the other in order to actuate the clutch 1.

The clutch bodies 2, 3 each have face splines 4, 6 which may be formed as claw-type toothing. The claw-type toothing in addition has a roof-type toothing. The teeth 4.1, 6.1 of the claw-type toothings 4, 6 each have tooth flanks 4.2, 6.2 which are arranged parallel or almost parallel to each other.

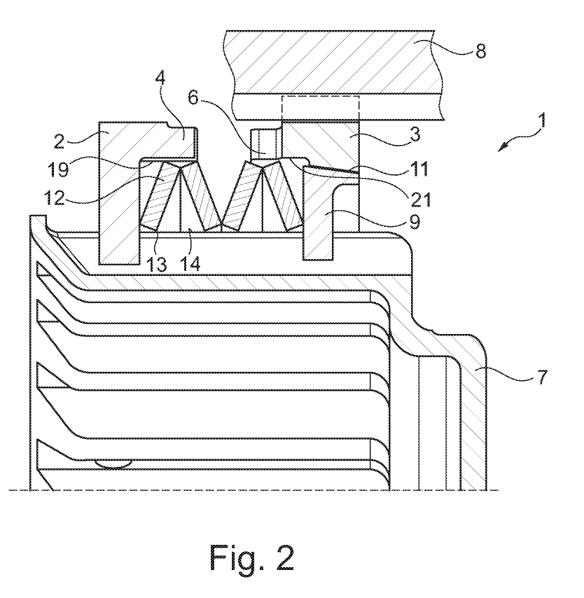

The first clutch body 2 according to FIG. 2 is connected rotationally fixedly to a first gear part 7, e.g. a shaft or a carrier. The second clutch body 3 is connected rotationally fixedly to a second gear part 8, e.g. a housing or a sleeve with internal toothing. The second clutch body 3 has a synchronizer ring 9 which is connected rotationally fixedly to the first gear part 7 and has a common friction face 11 with the clutch body 3. The friction face 11 is may be formed as a peripheral conical friction face 11. Depending on application, a multi-cone system may be used with several synchronizer rings having peripheral conical friction faces.

An annular spring 12, e.g. a cup spring or a cup spring packet, is provided between the clutch bodies 2, 3. This spring coaxially surrounds the gear part 7, is arranged inside the face splines 4, 6, and is supported axially firstly on the clutch body 2 and secondly on synchronizer ring 9. The inner periphery 13 of the cup spring 12 is guided on a guide 14, e.g. the outer periphery of the gear part 7. The cup spring 12 is here axially supported against an end face 16 of the clutch body 2 and an opposite end face 17 of the synchronizer ring 9. It may also be possible to guide the outer periphery 18 of the cup springs 12 using radially oriented stop faces 19, 21 formed on the clutch bodies 2, 3 as guides.

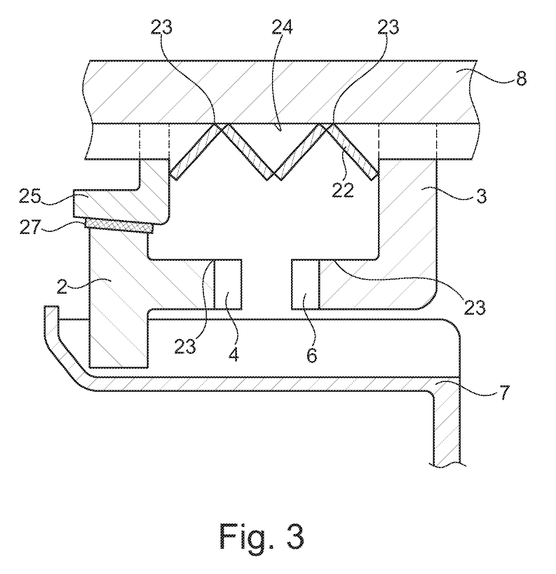

In a second exemplary embodiment according to FIG. 3, in comparison with the first exemplary embodiment, at least one cup spring 22, e.g., a cup spring packet, is provided which has a greater diameter than the cup spring 12 in order to transmit greater forces to a synchronizer ring 25 and generate greater return forces for releasing the clutch 1 or separating the clutch bodies 2, 3. To this end, the cup spring 22 surrounds the face splines 4, 6 of the clutch bodies 2, 3 coaxially, and its outer diameter 23 is supported and axially guided on a guide 24, in particular on an inwardly oriented radial stop of the housing. The synchronizer ring 25 has a greater diameter to provide a larger friction face 27 with the clutch body 2, is arranged coaxially outside the clutch body 2, and is connected rotationally fixedly to the gear part 8.

By combination of the exemplary embodiments in FIGS. 2 and 3, it is possible to assign a synchronizer ring 9, 25 to each clutch body 2, 3. These are then arranged radially offset to each other.

### REFERENCE SYMBOLS

1 Clutch
2 Clutch body
3 Clutch body
4 Face splines (2)
4.1 Tooth
4.2 Tooth flank
4.3 Roof-type toothing
6 Face splines (3)
6.1 Tooth
6.2 Tooth flank
6.3 Roof-type toothing
7 Gear part (gear)
8 Gear part (shaft)
9 Synchronizer ring
11 Friction face
12 Cup spring
13 Inner diameter (12)
14 Guide
16 End face (2)
17 End face (9)
18 Outer diameter (12)
19 Guide (2)
21 Guide (3)
22 Cup spring
23 Outer diameter (22)
24 Guide
25 Synchronizer ring
27 Friction face

1.-10. (canceled)

11. A clutch comprising:
a first disk-shaped clutch body comprising a first face spline formed as a first claw-type toothing;
a second disk-shaped clutch body comprising a second face spline formed as a second claw-type toothing, the second disk-shaped clutch body being axially spaced from the first disk-shaped clutch body and axially movable against the first disk-shaped clutch body to engage the second face spline with the first face spline; and,
a synchronizing mechanism for synchronizing a rotational speed of the first disk-shaped clutch body to a rotational speed of the second disk-shaped clutch body.

12. The clutch of claim 11, wherein:
the first claw-type toothing includes a first roof-type toothing and first pairs of tooth flanks formed substantially parallel to each other; and,
the second claw-type toothing includes a second roof-type toothing and second pairs of tooth flanks formed substantially parallel to each other.

13. The clutch of claim 11 further comprising a spring disposed between the first disk-shaped clutch body and the second disk-shaped clutch body.

14. The clutch of claim 13, further comprising a first gear part, wherein the spring is a cup spring or a cup spring packet coaxially surrounding the first gear part.

15. The clutch of claim 14, further comprising a guide for securing the cup spring or the cup spring packet against radial displacement.

16. The clutch of claim 15, wherein:
the first gear part comprises an outer periphery that forms the guide; and,
the spring comprises an inner periphery that is radially supported and axially guided on the outer periphery.

17. The clutch of claim 15, wherein:
the first disk-shaped clutch body or the second disk-shaped clutch body comprises a radial stop that forms the guide; and,
the spring comprises an outer periphery that is radially supported and axially guided on the radial stop.

18. The clutch of claim 15, further comprising a housing with an inwardly oriented radial stop that forms the guide, wherein the spring comprises an outer periphery that is radially supported and axially guided on the inwardly oriented radial stop.

19. The clutch of claim 13, wherein:
the first disk-shaped clutch body of the second disk-shaped clutch body comprises a first axially oriented end face that supports the spring; and,
the synchronizer mechanism comprises a synchronizer ring with a second axially oriented end face that supports the spring.

20. The clutch of claim 11, wherein:
the synchronizer mechanism comprises a synchronizer ring; and,
the synchronizer ring comprises a peripheral conical friction face that is frictionally connectable to the first disk-shaped clutch body or the second disk-shaped clutch body.
